(19) United States
(12) Patent Application Publication
(10) Pub. No.: US 2006/0017676 A1
(43) Pub. Date: Jan. 26, 2006

(54) Large substrate flat panel inspection system

(76) Inventors: Gerald M. Bowers, Boonville, CA (US); Joseph Henry Lanfrankie, Willitis, CA (US); Clarence E. Thomas, Knoxville, TN (US); Paul H. Wright, Willitis, CA (US)

Correspondence Address: JOHN BRUCKNER, P.C., 5708 BACK BAY LANE, AUSTIN, TX, 78739, US

(21) Appl. No.: 11/188,383

(22) Filed: Jul. 25, 2005

Related U.S. Application Data
(60) Provisional application No. 60/590,571, filed on Jul. 23, 2004.
(60) Provisional application No. 60/590,572, filed on Jul. 23, 2004.
(60) Provisional application No. 60/590,593, filed on Jul. 23, 2004.

(51) Int. Cl. G09G 3/36

(52) U.S. Cl. 345/87

(57) ABSTRACT

Methods and apparatus are described for large substrate flat panel inspection systems. A method includes inspecting an object using a machine that includes an imaging device having an electronic shutter: scanning the imaging device across a surface of the object between a first location and a second location; strobing at least one light emitting diode to illuminate the object between the first location and the second location; and synchronizing operation of the electronic shutter with the strobed at least one light emitting diode, wherein i) strobing the at least one light emitting diode includes firing the at least one light emitting diode using at least one index mark located on the machine and ii) scanning includes continuously moving the imaging device between the first location and the second location. An apparatus includes an inspection machine including: an imaging device having an electronic shutter; and at least one light emitting diode coupled to the imaging device, wherein i) the at least one light emitting diode is strobed by firing the at least one light emitting diode using at least one index mark located on the inspection machine while moving the imaging device continuously between a first location and a second location and ii) operation of the electronic shutter is synchronized with strobing of the at least one light emitting diode.

### CROSS-REFERENCES TO RELATED APPLICATIONS

This application is related to, and claims a benefit of priority under 35 U.S.C. 119(e) from copending provisional patent applications U.S. Ser. No. 60/590,571, filed Jul. 23, 2004; U.S. Ser. No. 60/590,572, filed Jul. 23, 2004; and U.S. Ser. No. 60/590,593, filed Jul. 23, 2004, the entire contents of all of which are hereby expressly incorporated herein by reference for all purposes.

### BACKGROUND INFORMATION

1. Field of the Invention

The inventions relates generally to the field of metrology. More particularly, embodiments of the invention relate to large substrate flat panel inspection systems.

2. Discussion of the Related Art

Flat panel display inspection systems are known to those of skill in the art. U.S. Pat. No. 5,764,209 discloses a flat panel display inspection system. U.S. patent application. No. 2003/014070 discloses a method and apparatus for position-dependent optical metrology calibration.

There is a need for improved flat panel display inspection equipment and methods. In particular, as flat panel displays grow larger and more popular, there is an increasing need for fast inspection systems.

### SUMMARY OF THE INVENTION

There is a need for the following embodiments of the invention. Of course, the invention is not limited to these embodiments.

According to an embodiment of the invention, a process comprises: inspecting an object using a machine that includes an imaging device having an electronic shutter: scanning the imaging device across a surface of the object between a first location and a second location; strobing at least one light emitting diode to illuminate the object between the first location and the second location; and synchronizing operation of the electronic shutter with the strobed at least one light emitting diode, wherein i) strobing the at least one light emitting diode includes firing the at least one light emitting diode using at least one index mark located on the machine and ii) scanning includes continuously moving the imaging device between the first location and the second location. According to another embodiment of the invention, an apparatus comprises an inspection machine including: an imaging device having an electronic shutter; and at least one light emitting diode coupled to the imaging device, wherein i) the at least one light emitting diode is strobed by firing the at least one light emitting diode using at least one index mark located on the inspection machine while moving the imaging device continuously between a first location and a second location and ii) operation of the electronic shutter is synchronized with strobing of the at least one light emitting diode.

These, and other, embodiments of the invention will be better appreciated and understood when considered in conjunction with the following description and the accompanying drawings.

It should be understood, however, that the following description, while indicating various embodiments of the invention and numerous specific details thereof, is given by way of illustration and not of limitation. Many substitutions, modifications, additions and/or rearrangements may be made within the scope of an embodiment of the invention without departing from the spirit thereof, and embodiments of the invention include all such substitutions, modifications, additions and/or rearrangements.

### BRIEF DESCRIPTION OF THE DRAWINGS

The drawings accompanying and forming part of this specification are included to depict certain embodiments of the invention. A clearer conception of embodiments of the invention, and of the components combinable with, and operation of systems provided with, embodiments of the invention, will become more readily apparent by referring to the exemplary, and therefore nonlimiting, embodiments illustrated in the drawings, wherein identical reference numerals (if they occur in more than one view) designate the same elements. Embodiments of the invention may be better understood by reference to one or more of these drawings in combination with the description presented herein. It should be noted that the features illustrated in the drawings are not necessarily drawn to scale.

FIG. 1 is an orthographic view of a brightfield and/or darkfield illumination and image acquisition system, representing an embodiment of the invention.

FIG. 2 is a perspective view of a horizontal arrangement tool, representing an embodiment of the invention.

FIGS. 3A-3C are orthographic views of the horizontal arrangement tool illustrated in FIG. 2.

FIGS. 4A-4C are orthographic views of a vertical arrangement tool, representing an embodiment of the invention.

FIG. 5 is a perspective view of the vertical arrangement tool illustrated in FIGS. 4A-4C.

FIG. 6 is another perspective view of the vertical arrangement tool illustrated in FIGS. 4A-4C and FIG. 5.

FIG. 7 is a perspective view of the vertical arrangement tool illustrated in FIGS. 4A-4C, FIG. 5 and FIG. 6 mounted in an enclosure with a control console, representing an embodiment of the invention.

### DESCRIPTION OF PREFERRED EMBODIMENTS

Embodiments of the invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the embodiments of the invention in detail. It should be understood, however, that the detailed description and the specific examples, while indicating preferred embodiments of the invention, are given by way of illustration only and not by way of limitation.

Various substitutions, modifications, additions and/or rearrangements within the spirit and/or scope of the underlying inventive concept will become apparent to those skilled in the art from this disclosure.

Within this application several publications are cited at the end of the specification immediately preceding the claims after the section heading References. The disclosures of all these publications in their entireties are hereby expressly incorporated by reference herein for the purpose of indicating the background of embodiments of the invention and illustrating the state of the art.

The below-referenced U.S. patent and U.S. patent application disclose embodiments that are useful for the purposes for which they are intended. The entire contents of U.S. Pat. No. 5,764,209 are hereby expressly incorporated by reference herein for all purposes. The entire contents of U.S. patent application No. 20030147070 are hereby expressly incorporated by reference herein for all purposes.

Overview

The invention can include a large substrate flat panel inspection system. The tool is designed to inspect large flat glass panels for pattern and particle defects including the various defect sub-classifications. It can be used for inspection of any form of patterned or unpatterned flat-panel and is not limited to displays. Typical panels include flat panel displays (FPD), thin film transistors (TFT), organic light emitting diodes (OLED), photomasks and the like. The design of the invention is uniquely flexible and modular, allowing single system architecture for substrate inspection of virtually all panel sizes at various defect resolutions ranging from 100 nm to greater than 10 microns. Customized to inspect various size panels per customer specification, the machine can accept substrates nominally ranging from 300 mm×350 mm (12″×14″) to 2,500 mm×3,000 mm (100″×120″). Of course, embodiments of the invention can be configured to accommodate larger or smaller substrates.

Architecture

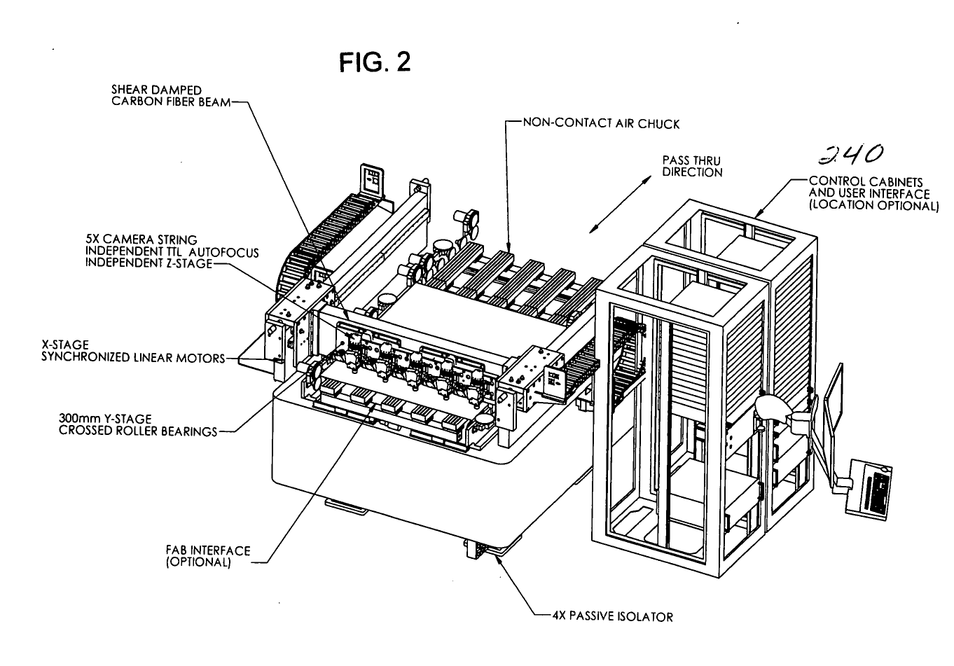

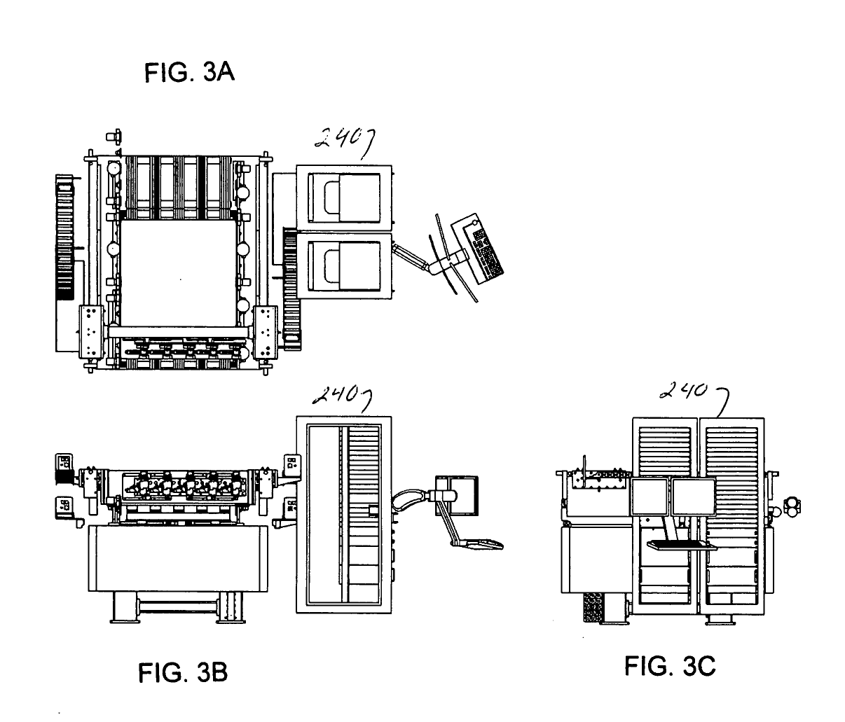

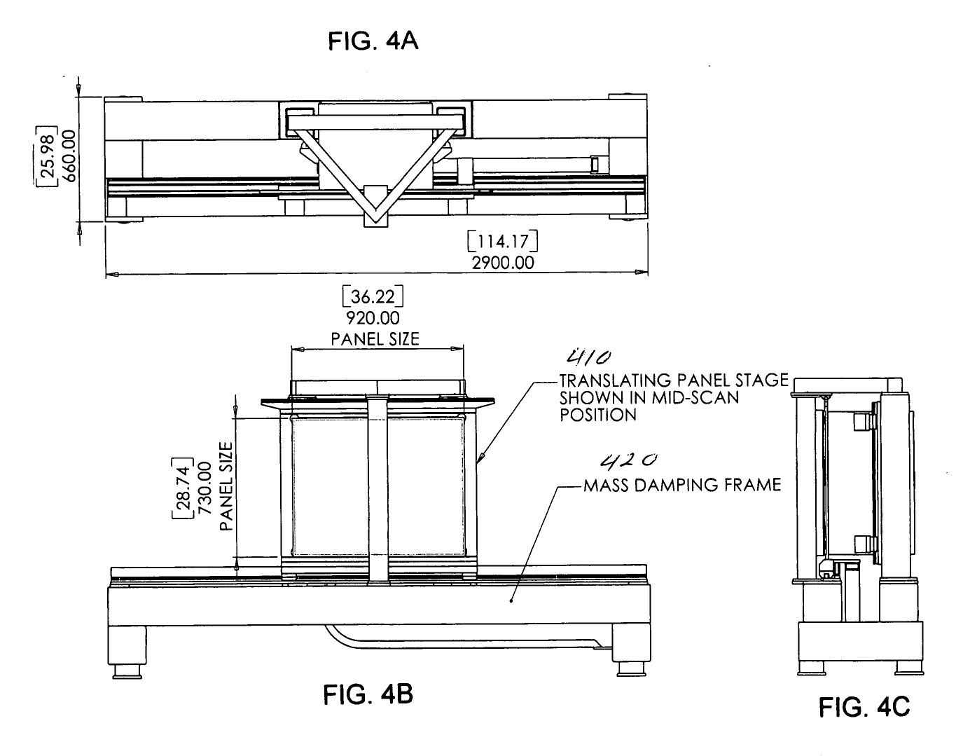

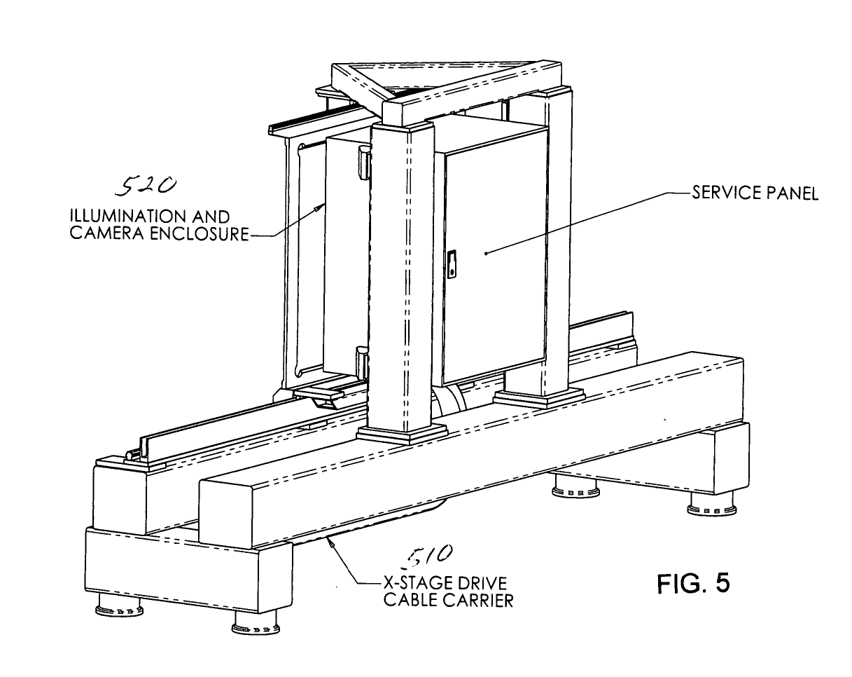

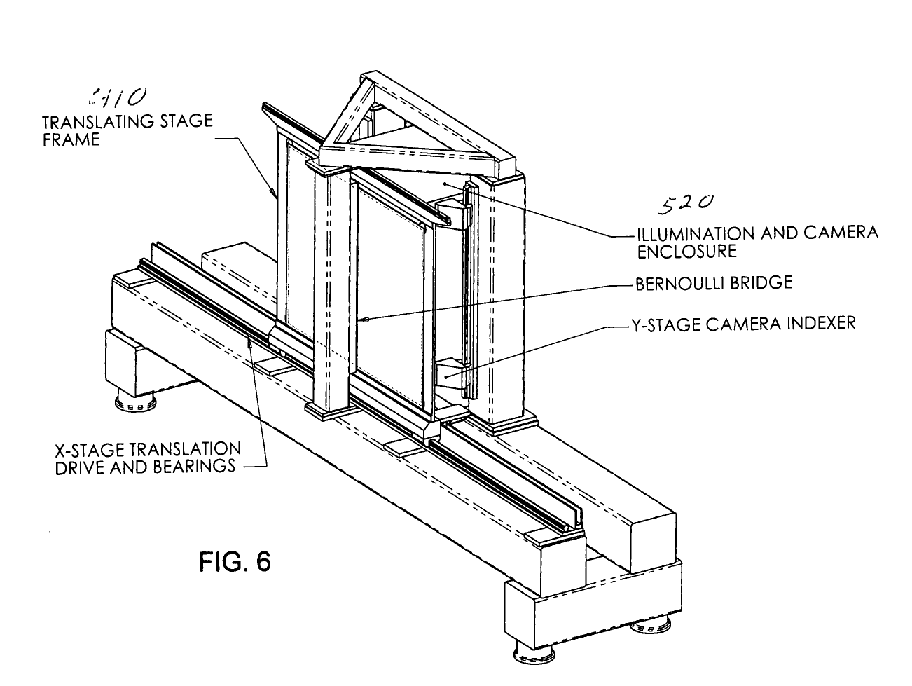

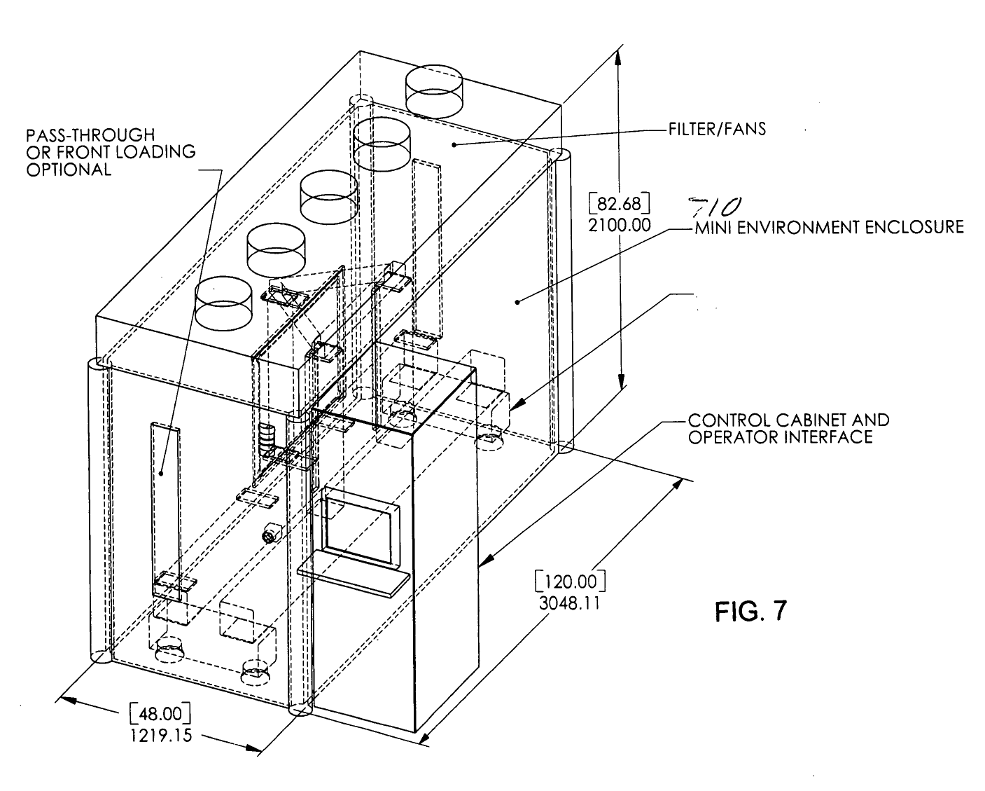

There are three preferred arrangements of the tool. Each arrangement is a designated by the orientation of the target substrate panel during inspection. These are: 1) horizontal; 2) vertical; and 3) near vertical. FIGS. 2 and 3A-3C illustrate the preferred ‘horizontal’ inspection arrangement of the tool. FIGS. 4A-4C, 5 and 6 illustrate a typical ‘vertical’ arrangement of the tool. FIG. 7 shows the same vertical tool arrangement mounted in a classified mini-environment with the control console attached. Control console placement is optional.

The embodied system employs a gantry style motion system for inspection. To reduce machine footprint for processing very large substrates, the panel is loaded and parked. The optics are flown over the panel in a boustrophedonic (writing alternate lines in opposite directions) scan. Dual linear motion axes move the optics along the long panel axis in a continuous fashion. A second simpler indexed axis steps the optics across the short axis of the panel between subsequent passes.

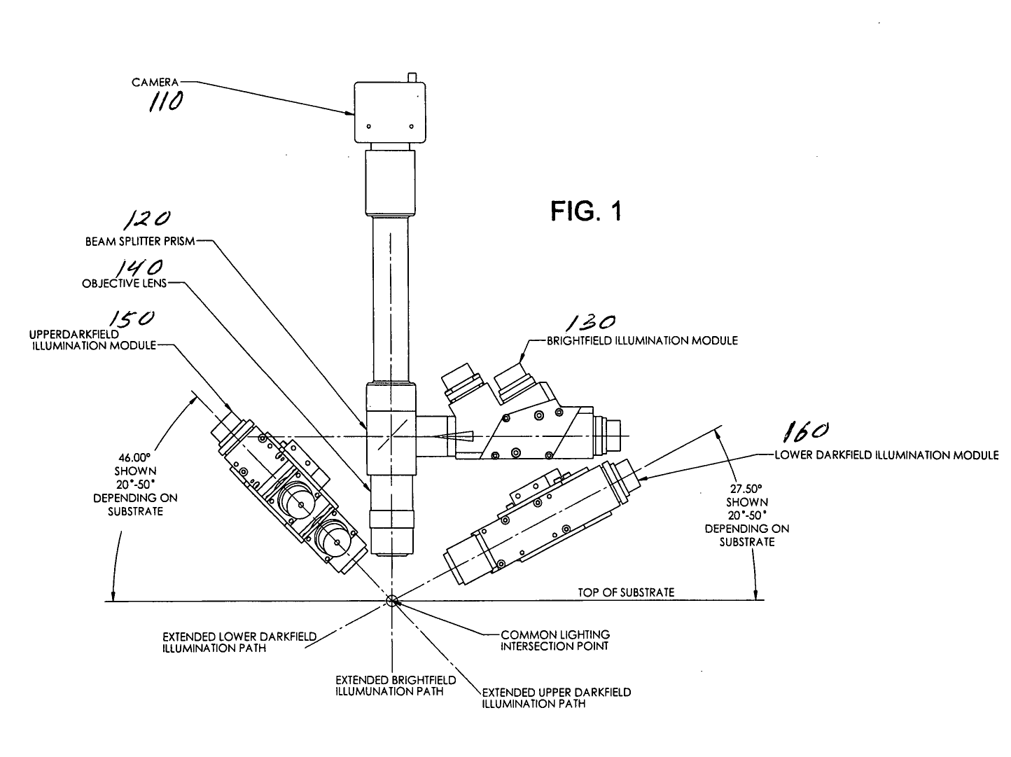

The defect detection system employs CCD (charge coupled device) or CMOS (complimentary metal oxide silicon) digital cameras with brightfield and/or darkfield strobed (pulsed) LED (light emitting diode) illumination and diffraction limited, readily commercially available optics as a preferred method. FIG. 1 illustrates a preferred camera-LED-optical arrangement. Specific illumination color can be derived by individually controlling the intensity of three LEDs. Using strobed illumination allows the scan motion and velocity to be continuous thus eliminating stop/start motion with its inherent settling time, position errors and machine motion complexity.

At the same time, the strobe relaxes the gantry specifications because the fast strobing freezes motion in the image plane. Finally, position pulses are output directly from the motion controller (at the hardware level) at predetermined scan coordinates. This direct output is used to trigger the camera exposure and illumination strobe, thus eliminating the need for calculated positions and precise gantry velocities and accelerations.

Algorithms

The image processing software can operate in several modes including: cell-to-cell comparison, die-to-die comparison, and die or cell to database comparison. For ultimate sensitivity to random defects, the cell-to-cell or die-to-die comparison modes are the methods of choice. For finding repeating defects and for reduced sensitivity to process variation, the cell or die-to-database comparison is the favored method and produces outstanding results for finding repeating defects and eliminating the effects of process variation.

Performance

The system can inspect substrates with defects at the “standard” defect design size of 5 μm in one pass. Smaller or larger defect sizes can be easily accommodated by changes in the optics components so that smaller or larger minimum defect sizes are inspected in a single pass. For defects smaller than the “standard” minimum resolution or for low-contrast defects a higher resolution is used. This higher resolution is accomplished by reducing the pixel size through objective/magnification change. Maximum stage velocity is at least 150 mm/sec and is calculated to match the camera size and standard minimum defect resolution to camera speed. The time required to inspect an 1100 mm×1300 mm panel is ˜60 seconds at a standard (5 μm) resolution. Inspection time for an 1100 mm×1300 mm panel at 2 μm resolution is ˜360 seconds, and the inspection time for 1 μm defects on the same panel is ˜25 minutes. The standard defect size (smallest magnification) can be reduced and the time for inspection similarly reduced as alternative embodiments. This requires additional optical hardware modules.

Options

Engineering defect review at higher resolution and sensitivity (to 100 nm) on the tool. (Requires a single camera on separate high-speed y-stage.)

Auto focus system automatically keeps the system in-focus regardless of manufacturer-allowable variations in the substrate.

Customized Calibration Standards for periodic recalibration

Custom software for customer-requested enhancements and factory management interfacing.

Functional Specifications

The invention can map 5 μm and larger pattern or particle defects at standard resolution. Alternative standard resolutions can be designed.

The invention can map 3 μm, and 1 μm defects with objective/magnification change.

The invention can work with thin substrates from 0.5 mm to 1.5 mm thick as well as 8 to 15 mm thick photomasks. Alternative thickness limits can be embodied.

The invention can employ CCD or CMOS cameras with strobed illumination and diffraction-limited brightfield and/or darkfield optics architecture.

The invention can inspect full panels at the standard resolution (5 μm defects) in 60 seconds, not including load and unload overheads, but including all inspection overheads. Inspection overheads are all overheads after the substrate is loaded and reaches initial “home” position under the inspection head.

The invention can include cell-to-database or cell-to-cell/die-to-die image processing software allows repeating defect or random defect detection modes.

The invention can include an engineering software mode for inspection recipe development.

The invention can include inclusion (Area of Interest, AOI) and exclusion software masks allowing for higher-speed inspection with improved false-count elimination.

The invention can include industry-standard defect file outputs.

The invention can include a graphical User Interface (GUI) for simple operator interface. GUI software follows industry human/machine interface (HMI) standards.

Optics Module Description

Cameras

The invention can use multiple commercially available area-scan (two-dimensional array) CCD and/or CMOS high-speed digital cameras. Camera frame rates range from 20 frames per second (FPS) to 500 FPS with array sizes ranging from 1.3 Mpixel to over 14 Mpixels. The presently preferred embodiment uses a 2 Mpixel camera at 30 FPS with strobed illumination, brightfield illumination, and a continuous boustrophedonic scan.

Imaging Optics

The imaging optics can be readily commercially available lenses from commercial and industrial suppliers. The objectives can be chosen to be infinity corrected or infinity corrected (telecentric) and typically are plan (flat-field), Apochromatic (color-corrected), and long-working-distance (LWD). For through the lens illumination (brightfield), a beamsplitter is used in front of the objective (between the sensors of the camera and the objective) to introduce the light into the objective from whence it travels to the object. A polarizing beamsplitter and quarter-wave-plate combination can be used to improve the efficiency to close to 100% of the light striking the target reaching the camera, even with through-the-lens illumination. For infinity-corrected objectives a tube-lens may be required to image the infinity-corrected light from the objective on the camera plane.

Illumination

The preferred embodiment uses a strobed solid state LED lighting source. These units have typical rise and fall times of 1 microsecond, so that pulses under 10 microseconds can be used. Illumination color can be tuned for optimum defect detection with derived chromatics. Colors are created by adjusting intensities of the red, blue and green LED's.

The illumination optics in general consist of a reflector (in the case of a lamp source), a condenser to collect light, an aperture to define the light field at the target, and a field lens to either image the aperture on the target, or to match the aperture to the imaging optic (for through-the-lens illumination) so that the aperture is imaged through the imaging lens on the target at the correct magnification. The illumination optics may incorporate a cylindrical lens in the case of a line-scan camera to better match the illumination to the target FOV. For darkfield illumination, considerations are similar except that no beamsplitter is required. In all cases suitable apertures, baffles, and darkening of structures is used to prevent stray light and external light sources from reaching the camera.

Optical Example

Referring to FIG. 1, a camera 110 is coupled to a beam splitter prism 120. A brightfield illumination module 130 is coupled to the beam splitter prism 120. An objective lens 140 is coupled to the beam splitter prism 120. An upperdarkfield illumination module 150 is coupled to the objective lens 140. A lowerdarkfield illumination module 160 is coupled to the objective lens 140. The modules 150,160 can be position at an angle from the horizontal of from 20 to 50 degrees. Each of the modules 130, 150, 160 includes three individually output controlled light emitting diodes of different color bands (i.e., red, green, yellow). It can be appreciated that this embodiment of the invention can be operated in brightfield and/or darkfield modes.

Mounting Systems

The mounting systems for all the optical components should be thermally stable, kinematic mounts with high stability. The mounts are all either pinned, cornered, or aligned against rails so that they can be removed and replaced from/to the optical bridge gantry structure with high accuracy, thus allowing easy cleaning and replacement of optics.

System Modularity

The camera, imaging, and illumination system is designed as a modular component, so that additional modules can be easily added or removed in order to inspect different size components, or to inspect the same-size component with different pixel sizes at similar speeds.

Auto Focus

To obtain short inspection times, and to eliminate the need for “stop and stare” techniques, on-the-fly auto focus is used for each independent optical string. Feedback from either external or preferred through-the-lens laser distance sensors is used to drive each optical Z-Stage to keep optics in focus with regards to the substrate.

Because the auto focus is real time, stage and chuck flatness and repeatability specifications are more relaxed than those required for a pre-scan type system.

Defect Review Camera System and Stage

A separate defect review camera can be provided. It has the typical system modular optics architecture and is supplied with camera and imaging optics customized to meet system performance specifications.

Mechanical Systems Description

Machine Base

The entire inspection tool can sit on a modular machine base with pneumatic passive vibration damping mounts. The primary purpose for the base is to damp resultant motion forces. The base can also aid in elimination of ambient building and other mechanical vibration sources.

Table

Because system design allows for scanning and imaging with continuous motion and relaxed velocity requirements, the table mass and the ratio of moving mass to stationary mass can be reduced from traditional machine designs. Additionally, due to the extreme sizes of Generation 7 and Generation 8 substrate panels it is highly desirable for the table to be of modular design and construction. The typically used granite table construction does not lend itself to meet either of these requirements. Two embodiment options are a composite honeycomb structure and a steel weldment structure. Both can be modular and both can be designed to exhibit high stiffness and favorable damping characteristics.

Gantry

Motion of the target panel past the camera array is provided by ‘flying’ the support bridge and optics over the stationary substrate. The X-Stage structure and its motion devices can be designed to be rigid and highly vibration damped using sheer-damping and other appropriate techniques in its construction. This motion is provided by a high resolution, relatively low accuracy, smooth gantry system with dual motor drive X-Axes. The X-Axes includes support beams, linear bearings, linear motors, and robust non contact optical encoders. The linear bearings may be either recirculating precision ball bearings, or air bearings. The specific type of bearing used is chosen to be compatible with the tolerance requirements of the optical detection system which dictates the required smoothness. Gantry X direction power is provided by dual linear motors mounted to the linear bearing assembly.

The Y-Stage is used to provide incremented transverse travel distance offsets to all of the optics modules in unison for subsequent passes by the X-Stage.

Bridge

The optics bridge beam itself is rigid and damped. Two high stiffness damped carbon fiber channels are constructed and then joined with sheer vibration damping techniques to provide a stiff, light, and highly damped bridge beam. The application of structural carbon fiber results in a very stiff light weight beam structure with very low mass. The low mass is critical to high speed accurate positioning of the attached optical components.

Load/Unload and Support Chuck

The system is optionally capable of operating in either a ‘through system’ mode where the panel is loaded on one end of the system and unloaded on the opposite end, or in a ‘return to first position’ mode where the panel is input and output on the same end of the system. Mechanical interfaces may be provided to accommodate either on-edge or flat arrival of panels and can include the ability to directly connect to other flat panel manufacturing machines. Panels are transferred on either porous air bearings or air bearings with discrete air jets depending upon vertical stability requirements of the particular optics and resulting depth of field. Air bearings act as both load unload conveyors as well as support chucks.

Theta-Adjustment

Once loaded, the panel can be automatically aligned through an active positioning system. This active positioning system can mechanically align the panel with the inspection system within relatively course limits. Its travel can be limited to a few degrees. The preferred construction of the Theta-adjustment is to provide a motor to drive a single corner of the panel support frame in a rotary direction about its horizontal axis. The Theta-adjustment axis rotation can be controlled by the system controller in response to optical measurements of alignment marks or other patterns detected by optical detectors focused on the target FPD panel.

Cable Management

The necessary cables (electric, mechanical, and pneumatic) servicing the moving components are be routed through a commercial cable track or carrier.

Horizontal Example

Referring to FIGS. 2 and 3A-3C, a horizontal example of the invention is depicted. A Y-stage 210 includes crossed roller bearings. An X-stage 220 include synchronized linear motors. Five cameras are mounted on a shear damped carbon fiber beam 230. A set of control cabinets and user interface 240 are depicted in close proximity, but the location is optional.

Vertical Example

Referring to FIGS. 4A-4C and 5-6, a vertical example of the invention is depicted. A translating panel stage 410 is coupled to a mass damping frame 420. An X-stage drive cable carrier 510 is located in the frame 420. An illumination and camera enclosure 520 is mounted on the frame 420.

Environmental Controls Description and Operation

Referring to FIG. 7, a freestanding clean room classified mini-environment 710 can be optionally provided for the inspection system. The mini-environment can be constructed from non-particulating static dissipative materials and equipped with the appropriate fan filter units to deliver ˜90 linear feet/minute vertical airflow over the entire enclosed area. Optional flow, air ionization and particle monitor controls can be provided and interfaced to the GUI or factory management controllers. The mini-environment can be equipped with appropriate passive vibration isolation to eliminate transmission of undesirable vibrations to the inspection system.

GUI Systems Description

Operator Interface

The operator interface functions of the Graphical User Interface (GUI) allow the operator to start and stop inspections, or load and unload recipes from a database for application to particular parts to be inspected. It also provides defect-map and defect size binning for the part under inspection during an inspection and for review after the inspection is complete.

Engineering Interface

The engineering interface functions of the GUI allow complete control of all individual digitally controlled automated components of the system. It also allows creation and saving to a database of recipes dedicated to inspection of a particular part or type of part. Pixel sizes (magnification), inspection speed, frame rates, include and exclude areas, care areas, inspection type (cell-to-cell, cell-to-database, . . . ), etc. The Engineering Interface also allows image processing and image diagnostics to be run to verify operation of the software and hardware. All sub-systems under the system control (e.g., auto focus) can be controlled and adjusted through the Engineering Interface of the GUI. Similarly, all parameters are saved to a recipe. A default reset is available to return all parameters to their defaults in case out of range settings are achieved that make the system inoperable.

Recipe Setup

The recipe setup interface allows (under the Engineering Interface) specific inspection recipes to be set up and saved. Control items include the (0,0) Home location for the inspection; parameters to be used for auto-aligning the system; parameters defining the areas to be inspected and those to be excluded; parameters defining the operation of the auto focus system; parameters defining the cell and/or die size; image processing parameters defining filters or other algorithms to be used in processing the images, etc.

Cell to Cell or Die-to-Die Inspection

Under cell-to-cell or die-to-die inspection, individual and identical cells/dies are subtracted from one another after suitable image processing (filtering, equalization, alignment, etcetera) to identify differences or defects.

Cell or Die to Database Inspection

Suitable descriptions (effectively processed images) of a cell or die are saved to a database and the cell or die under inspection is subtracted from the database cell or die.

An embodiment of the invention can also be included in a kit-of-parts. The kit-of-parts can include some, or all, of the components that an embodiment of the invention includes. The kit-of-parts can be an in-the-field retrofit kit-of-parts to improve existing systems that are capable of incorporating an embodiment of the invention. The kit-of-parts can include software, firmware and/or hardware for carrying out an embodiment of the invention. The kit-of-parts can also contain instructions for practicing an embodiment of the invention. Unless otherwise specified, the components, software, firmware, hardware and/or instructions of the kit-of-parts can be the same as those used in an embodiment of the invention.

### Advantages

Embodiments of the invention can be cost effective and advantageous for at least the following reasons. Embodiments of the invention can include modular and scaleable optics and boustrophedonic scan for balance of defect size, TACT time and system cost. Embodiments of the invention can include an architecture the lends itself to through system in-line or off-line applications. Embodiments of the invention can include fixed panel and flying optics for small machine footprint. Embodiments of the invention can include horizontal, vertical, or near vertical architectures for integration in to a range of fabrication facilities. Embodiments of the invention can include strobed illumination and fast exposure for continuous scan. Embodiments of the invention can include strobed illumination and fast exposure for non-standard machine design with light table. Embodiments of the invention can include hardware based position triggering for reduced velocity stability. Embodiments of the invention can include a modular design and a relatively lighter table for improved logistics. Embodiments of the invention can include a stiff and damped bridge beam for focus stability. Embodiments of the invention can include independent on-the-fly auto focus for relaxed stage and chuck positioning specifications. Embodiments of the invention can include non-contact air bearing rails act as conveyor and chuck. Embodiments of the invention can include long working distance and long depth of field optics for robust focus. Embodiments of the invention can include independently controlled illumination LED's for derived colors and improved defect detection. Embodiments of the invention can include powerful image processing software operating in cell-to-cell, die-to-die and die or cell to database comparisons. Embodiments of the invention improve quality and/or reduces costs compared to previous approaches.

### DEFINITIONS

The phrase brightfield illumination is intended to mean through the lens illumination, such as multi-LED lighting that is routed through a beamsplitter so as to shines through an objective lens before being reflected/scattered back through the objective lens by a sample. The phrase darkfield illumination is intended to mean illumination that does not shine through an objective lens before being scattered (e.g., reflected) through an objective lens by a sample (grazing darkfield illumination can cause specular reflections from abrupt surface irregularities). The phrase diffraction limited is intended to mean that the performance of a set of optics, such as the lens assembly coupled to a CCD, is limited by the diffractive nature of light, and not by other factors such as the quality of the optics. The term program and/or the phrase computer program are intended to mean a sequence of instructions designed for execution on a computer system (e.g., a program and/or computer program, may include a subroutine, a function, a procedure, an object method, an object implementation, an executable application, an applet, a servlet, a source code, an object code, a shared library/dynamic load library and/or other sequence of instructions designed for execution on a computer or computer system). The term substantially is intended to mean largely but not necessarily wholly that which is specified. The term approximately is intended to mean at least close to a given value (e.g., within 10% of). The term generally is intended to mean at least approaching a given state. The term coupled is intended to mean connected, although not necessarily directly, and not necessarily mechanically. The term proximate, as used herein, is intended to mean close, near adjacent and/or coincident; and includes spatial situations where specified functions and/or results (if any) can be carried out and/or achieved. The term deploying is intended to mean designing, building, shipping, installing and/or operating.

The terms first or one, and the phrases at least a first or at least one, are intended to mean the singular or the plural unless it is clear from the intrinsic text of this document that it is meant otherwise. The terms second or another, and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), and both A and B are true (or present). The terms a or an are employed for grammatical style and merely for convenience.

The term plurality is intended to mean two or more than two. The term any is intended to mean all applicable members of a set or at least a subset of all applicable members of the set. The term means, when followed by the term “for” is intended to mean hardware, firmware and/or software for achieving a result. The term step, when followed by the term “for” is intended to mean a (sub)method, (sub)process and/or (sub)routine for achieving the recited result.

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. The terms “consisting” (consists, consisted) and/or “composing” (composes, composed) are intended to mean closed language that does not leave the recited method, apparatus or composition to the inclusion of procedures, structure(s) and/or ingredient(s) other than those recited except for ancillaries, adjuncts and/or impurities ordinarily associated therewith. The recital of the term “essentially” along with the term “consisting” (consists, consisted) and/or “composing” (composes, composed), is intended to mean modified close language that leaves the recited method, apparatus and/or composition open only for the inclusion of unspecified procedure(s), structure(s) and/or ingredient(s) which do not materially affect the basic novel characteristics of the recited method, apparatus and/or composition.

Unless otherwise defined, all technical and scientific terms used herein have the same meaning as commonly understood by one of ordinary skill in the art to which this invention belongs. In case of conflict, the present specification, including definitions, will control.

### Conclusion

The described embodiments and examples are illustrative only and not intended to be limiting. Although embodiments of the invention can be implemented separately, embodiments of the invention may be integrated into the system(s) with which they are associated. All the embodiments of the invention disclosed herein can be made and used without undue experimentation in light of the disclosure. Although the best mode of the invention contemplated by the inventor(s) is disclosed, embodiments of the invention are not limited thereto. Embodiments of the invention are not limited by theoretical statements (if any) recited herein. The individual steps of embodiments of the invention need not be performed in the disclosed manner, or combined in the disclosed sequences, but may be performed in any and all manner and/or combined in any and all sequences. The individual components of embodiments of the invention need not be formed in the disclosed shapes, or combined in the disclosed configurations, but could be provided in any and all shapes, and/or combined in any and all configurations.

It can be appreciated by those of ordinary skill in the art to which embodiments of the invention pertain that various substitutions, modifications, additions and/or rearrangements of the features of embodiments of the invention may be made without deviating from the spirit and/or scope of the underlying inventive concept. All the disclosed elements and features of each disclosed embodiment can be combined with, or substituted for, the disclosed elements and features of every other disclosed embodiment except where such elements or features are mutually exclusive. The spirit and/or scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

### REFERENCES

Marks Mechanical Engineering Handbook, 10th ed., McGraw Hill, (Eugene A. Avallone et al. eds.), 1996.
The Electrical Engineering Handbook, CRC Press, (Richard C. Dorf et al. eds.), 1993.
Handbook of Optics, Volumes I-II, 2nd ed., McGraw Hill Inc., (Michael Bass et a/. eds.), 1995.
Fundamentals of Photonics, John Wiley & Sons, Inc.), Saleh and Teich, 1991.

What is claimed is:

1. A method, comprising inspecting an object using a machine that includes an imaging device having an electronic shutter:
scanning the imaging device across a surface of the object between a first location and a second location;
strobing at least one light emitting diode to illuminate the object between the first location and the second location; and
synchronizing operation of the electronic shutter with the strobed at least one light emitting diode,
wherein i) strobing the at least one light emitting diode includes firing the at least one light emitting diode using at least one index mark located on the machine and ii) scanning includes continuously moving the imaging device between the first location and the second location.

2. The method of claim 1, wherein a) strobing includes repeatedly turning the at least one light emitting diode on and then off, b) the imaging device includes a plurality of sensors and c) synchronizing includes erasing the plurality of sensors before the at least one light emitting diode is switched on, then recording light scattered by the object with the plurality of sensors while the at least one light emitting diode is switched on and then reading data from the plurality of sensors after the at least one light emitting diode is switched off.

3. The method of claim 1, wherein scanning includes moving a gantry upon which the imaging device is mounted through a plane defined by the surface of the object.

4. The method of claim 3, wherein scanning includes moving the imaging device relative to the gantry to define a boustrophedonic scan.

5. The method of claim 3, further comprising high resolution imaging the surface of the object using another imaging device.

6. The method of claim 1, wherein using the at least one index mark includes using a plurality of index marks located on a motion platform of the machine.

7. The method of claim 1, wherein strobing includes individual output control of a plurality of light emitting diodes, each of the plurality of light emitting diodes emitting a different spectrum of color, to operate in a derived color mode.

8. The method of claim 1, wherein strobing includes brightfield illumination of the object by the at least one light emitting diode through an objective lens of the imaging device.

9. The method of claim 8, wherein brightfield illumination includes illuminating the object through a) an s polarizer located between the at least one light emitting diode and a beamsplitter and b) ¼ wavelength plate located between the beamsplitter and an objective lens, wherein the beamsplitter substantially reflects S polarized light and substantially transmits P polarized light.

10. The method of claim 1, wherein strobing includes darkfield illumination of the object by the at least one light emitting diode.

11. The method of claim 10, wherein strobing includes darkfield illumination of the object by at least another light emitting diode.

12. The method of claim 11, wherein the at least one light emitting diode illuminates the object at a first angle to a plane defined by the surface of the object and the at least another light emitting diode illuminates the object at a second angle to the plane defined by the surface of the object

13. The method of claim 12, wherein the first angle is substantially different than the second angle.

14. The method of claim 13,wherein the first angle is approximately 50 degrees and the second angle is approximately 30 degrees.

15. The method of claim 10, wherein darkfield illumination includes illuminating the object through a p polarizer located between the at least one light emitting diode and the object, wherein light scattered from the object passes through an S polarizer located between the object and a plurality of sensors of the imaging device.

16. The method of claim 1, wherein strobing includes brightfield illumination of the object by the at least one light emitting diode through an objective lens of the imaging device and darkfield illumination of the object by at least another light emitting diode.

17. A computer program, comprising computer or machine readable program elements translatable for implementing the method of claim 1.

18. A machine readable medium, comprising a program for performing the method of claim 1.

19. An apparatus, comprising an inspection machine including:
an imaging device having an electronic shutter; and
at least one light emitting diode coupled to the imaging device,
wherein i) the at least one light emitting diode is strobed by firing the at least one light emitting diode using at least one index mark located on the inspection machine while moving the imaging device continuously between a first location and a second location and ii) operation of the electronic shutter is synchronized with strobing of the at least one light emitting diode.

20. The apparatus of claim 19, wherein a) the at least one light emitting diode is strobed by repeatedly turning the at least one light emitting diode on and then off, b) the imaging device includes a plurality of sensors and c) operation of the electronic shutter is synchronized by erasing the plurality of sensors before the at least one light emitting diode is switched on, then recording light scattered by the object with the plurality of sensors while the at least one light emitting diode is switched on and then reading data from the plurality of sensors after the at least one light emitting diode is switched off.

21. The apparatus of claim 19, further comprising a gantry upon which the imaging device is mounted, the gantry moving the imaging device through a plane.

22. The apparatus of claim 21, wherein the imaging device is movable relative to the gantry, the imaging device moving to define a boustrophedonic scan.

23. The apparatus of claim 21, further comprising another imaging device mounted on the gantry.

24. The apparatus of claim 19, wherein using the at least one index mark includes a plurality of index marks located on a motion platform of the inspection machine.

25. The apparatus of claim 19, wherein the at least one light emitting diode includes a plurality of light emitting diodes, each of the plurality of light emitting diodes emitting a different spectrum of color and being individually output controlled to operate in a derived color mode.

26. The apparatus of claim 19, wherein the at least one light emitting diode illuminates an object of inspection through an objective lens of the imaging device.

27. The apparatus of claim 26, wherein the imaging device includes a) an s polarizer located between the at least one light emitting diode and a beamsplitter and b) a ¼ wavelength plate located between the beamsplitter and an objective lens, wherein the beamsplitter substantially reflects S polarized light and substantially transmits P polarized light.

28. The apparatus of claim 19, wherein the at least one light emitting diode illuminates an object, not through an objective lens of the imaging device.

29. The apparatus of claim 28, further comprising another light emitting diode that illuminates the object, not through an objective lens.

30. The apparatus of claim 29, wherein the at least one light emitting diode illuminates the object at a first angle to a plane defined by a surface of the object and the at least another light emitting diode illuminates the object at a second angle to the plane defined by the surface of the object

31. The apparatus of claim 30, wherein the first angle is substantially different than the second angle.

32. The apparatus of claim 31,wherein the first angle is approximately 50 degrees and the second angle is approximately 30 degrees.

33. The apparatus of claim 28, further comprising a p polarizer located between the at least one light emitting diode and the object and an S polarizer located between the object and a plurality of sensors of the imaging device.

34. The apparatus of claim 19, wherein the at least one light emitting diode illuminates an object through an objective lens of the imaging device and further comprising a another light emitting diode that illuminates the object, not through the objective lens.

35. The apparatus of claim 19, further comprising i) an enclosure defining a classified mini-environment and ii) a control console.
